(19) United States
(12) Patent Application Publication
(10) Pub. No.: US 2003/0026947 A1
(43) Pub. Date: Feb. 6, 2003

(54) Tantoo

(76) Inventor: Aram Piligian, Harleysville, PA (US)

Correspondence Address: Aram Piligian, 1081 Kingscote Drive, Harleysville, PA, 19438, US

(21) Appl. No.: 09/921,932

(22) Filed: Aug. 3, 2001

(51) Int. Cl. B32B 3/10

(52) U.S. Cl. 428/137; 428/343

(57) ABSTRACT

An adhesive patch with a patterned edge and/or cut out patterned interior to block and let sunlight through to the skin. By wearing this patch a person will develop a patterned suntan similar to a tattoo, which would show when the patch is removed.

### CROSS-REFERENCE TO RELATED APPLICATIONS

Not Applicable

### STATEMENT REGARDING FEDERALLY SPONSORED RESEARCH OF DEVELOPMENT

Not Applicable

### REFERENCE TO A MICROFICHE APPENDIX

Not Applicable

### BACKGROUND OF THE INVENTION

1. Technical Field

This invention relates to an adhesive patch to be applied to a person's skin to form a patterned suntan when said patch is removed.

2. Description of Related Art

Man has engaged in body decoration since ancient times. This has continued in modern times with tattoos and piercings. In some parts of society these permanent changes to one's body may be considered at the least unattractive and at the most unacceptable. Still many people want to express their individuality in some way. Tattoos and piercings however, are permanent and do not allow the wearer to change their mind.

The purpose of this invention is to allow a person to decorate their body in an temporary way. It provides the wearer with a patterned suntan which can vary in darkness depending on the sun exposure time. This pattern will fade and disappear as the person's tan changes. It provides a semi-permanent body decoration.

### SUMMARY OF THE INVENTION

The invention consists of an adhesive patch used to block the sun's tanning rays from reaching the wearer's skin. After sun exposure the patch will be removed and a patterned suntan will be revealed on the wearer's skin. The invention can also be placed on other materials to provide a masked area prior to painting. On skin make-up can be applied over the invention to reveal a temporary decorated area.

### BRIEF DESCRIPTION OF THE DRAWINGS

The invention is further described by the attached drawings wherein:

FIG. 1 is a top view of the invention showing a solid patch and patterned edge.

FIG. 2 is a top view of the invention showing a clean edge and a cut out within the field of the patch.

FIG. 3 is a top view of the invention showing a patterned edge and cut outs within the field of the patch.

FIG. 4 is a top view of the invention showing an example of a patterned edge and cut outs in a recognizable silhouette.

FIG. 5 is a top view of the invention showing an example of a patterned edge in a recognizable silhouette.

FIG. 6 is a view of the invention and its results after use. It show the wearer's skin with a patterned suntan after the invention is removed.

### DETAILED DESCRIPTION OF THE INVENTION

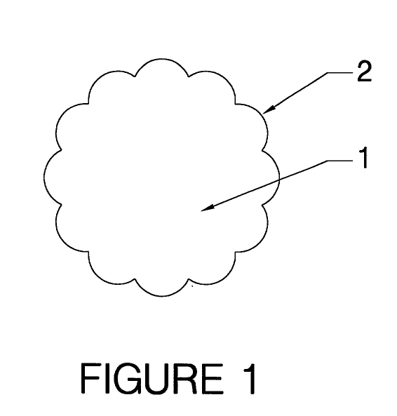

FIG. 1 shows the light blocking adhesive patch (#1) with a patterned edge (#2) to be applied to the skin. The patch consists of a vinyl material with a UV blocking characteristic and adhesive backing suitable for skin applications.

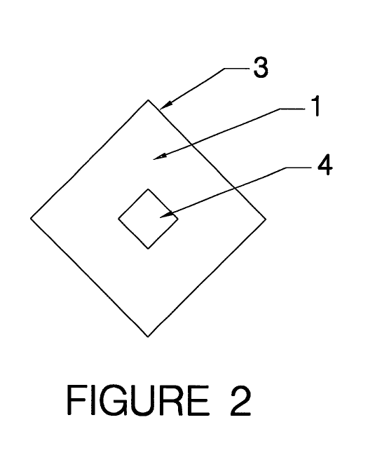

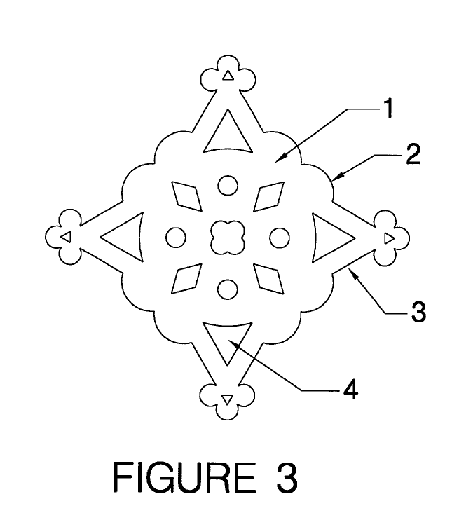

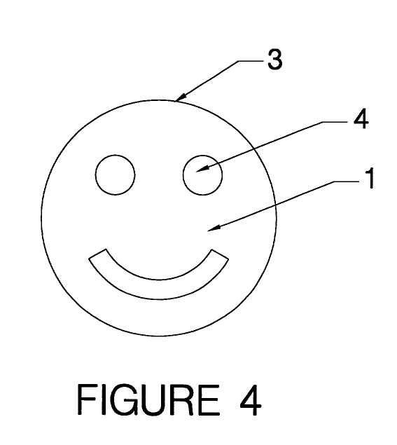

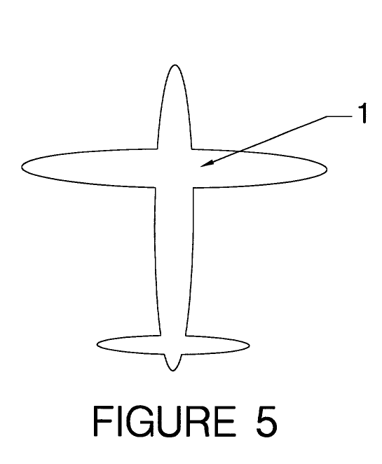

FIGS. 2, 3, 4 and 5 shows examples of the patch in different configurations. These indicate the light blocking adhesive patch (#1) with a patterned edge (#2), a clean edge (#3), and a cut out pattern (#4).

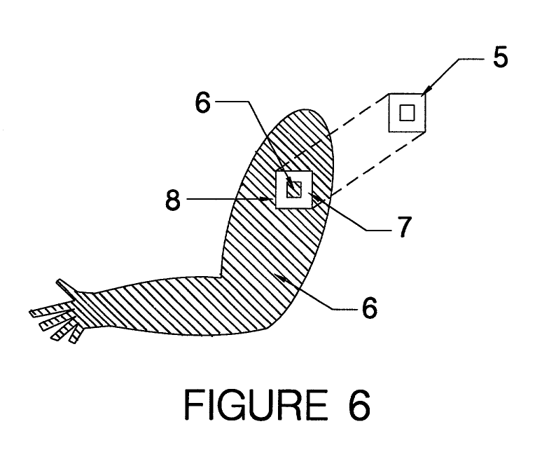

FIG. 6 shows the invention and the results after its use. The sunlight blocking adhesive patch (#5) is removed from the skin. The skin not covered by the sunlight blocking adhesive patch (#5) develops a suntan (#6). The skin that had been covered by the sunlight blocking adhesive patch (#5) shows no suntan pigmentation (#7). The combination of skin exposed to the sun's tanning rays and skin protected by sunlight blocking adhesive patch (#5) results in a patterned suntan (#8).

1. I claim that my invention is an adhesive patch for making a patterned suntan on the wearer's skin. Said patch will prevent the sun's rays from reaching the wearer's skin so that a suntan will not develop under the patch. Said patch will have a patterned edge so that when removed from the wearer's skin after sun exposure a patterned suntan will have developed.

2. An adhesive patch as claimed in claim 1, where said patch has internal cutouts to allow the sun's rays to pass through to the wearer's skin in a specific pattern.

3. An adhesive patch as claimed in claim 1, where said patch is waterproof.

4. An adhesive patch as claimed in claim 1, where said patch has various decorative colors on the exposed face, to provide an attractive appearance while the patch is worn.

5. An adhesive patch as claimed in claim 1, where said patch has a patterned edge and internal cutouts to allow the sun's rays to pass through to the wearer's skin in a specific pattern.
